(19) United States
(12) Patent Application Publication
(10) Pub. No.: US 2006/0201769 A1
(43) Pub. Date: Sep. 14, 2006

(54) Electromagnetic clutch for compressor

(75) Inventors: Takao Shimoyama, Isesaki-shi (JP); Yoshiyuki Suda, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Iseaki-shi (JP)

(21) Appl. No.: 11/361,000

(22) Filed: Feb. 24, 2006

(30) Foreign Application Priority Data
Feb. 24, 2005 (JP) 2005-048924
Feb. 25, 2005 (JP) 2005-050806

(51) Int. Cl. F16D 27/00

(52) U.S. Cl. 192/84.961

(57) ABSTRACT

The present invention provides an electromagnetic clutch for compressor which can align axial centers of a core ring and a rotor with high accuracy. In the present invention, since a support portion 22c for supporting a rotor 11 is provided integrally on a core ring 22, the core ring 22 can be formed coaxially with the support portion 22c, and the rotor 11 supported by the support portion 22c and the core ring 22 can be arranged on the same axial center without separate alignment. In this case, since a fixed portion 22b is engaged with an engagement portion 4c of a compressor body 4 so that movement in the radial direction is regulated, the core ring 22 is not displaced in the radial direction with respect to the compressor body 4, and the axial centers of the core ring 22 and a rotational axis 1 can be aligned with high accuracy. By this, a gap G between the core ring 22 and the rotor 11 can be made smaller, and the permeability between the core ring 22 and the rotor 11 can be improved.

### BACKGROUND OF THE INVENTION

1. Field of the Invention

The present invention relates to an electromagnetic clutch for compressor used in an air conditioner for vehicle, for example.

2. Description of the Related Art

As this type of electromagnetic clutch, in general, an electromagnetic clutch as shown in FIG. 14 is known which is provided with a core ring 2 arranged coaxially with a rotational axis 1 of a compressor, an electromagnetic coil 3 provided on the core ring 2, an annular rotor 6 rotatably supported on an outer circumferential face of a support portion 4a extending in the axial direction from a compressor body 4 via a bearing 5 and formed surrounding an outer circumferential face and an inner circumferential face of the core ring 2 and an armature 7 arranged opposite to one end face in the axial direction of the rotor 6, and it is so constituted that a torque of the rotor 6 is transmitted to the rotational axis 1 of the compressor by attracting the armature 7 to the one end face in the axial direction of the rotor 6 with a magnetic force of the electromagnetic coil 3 (See Japanese Patent Publication 08-247171, for example).

In order to improve permeability between the core ring 2 and the rotor 6, in the above electromagnetic clutch, it is necessary to reduce a gap in the radial direction between the core ring 2 and the rotor 6. But in the conventional electromagnetic clutch, a fixed ring 8 for supporting the core ring 2 on the compressor body 4 is welded on one end face in the axial direction of the core ring 2, and it is difficult to accurately align the axial centers of the core ring 2 and the fixed ring to each other due to displacement at welding. Therefore, in order to avoid contact between the core ring 2 and the rotor 6 due to displacement of the axial centers, the gap between the core ring 2 and the rotor 6 should be made larger. As a result, the permeability is lowered and magnetic resistance is increased, and there is a problem that an electric power to the electromagnetic coil 3 should be increased.

### SUMMARY OF THE INVENTION

The present invention was made in view of the above problems and it has an object to provide an electromagnetic clutch for compressor which can align axial centers of a core ring and a rotor with high accuracy.

In order to achieve the above object, the present invention is, in an electromagnetic clutch for compressor provided with a core ring arranged coaxially with a rotational axis of the compressor, an electromagnetic coil provided on the core ring, an annular rotor formed surrounding an outer circumferential face and an inner circumferential face of the core ring, in which the rotor is rotatably supported on an outer circumferential face of a support portion extending in the axial direction from the compressor body, a fixed portion to be fixed to the compressor body is provided integrally with the core ring and the fixed portion is engaged with the compressor body so that movement in the radial direction is regulated.

By this, since the fixed portion to be fixed to the compressor body is integrally provided on the core ring, the core ring can be formed coaxially with the fixed portion, and the core ring and the fixed portion can be arranged on the same axial center without separate alignment. In this case, since the fixed portion is engaged with the compressor body side so that movement in the radial direction is regulated, the fixed portion is not displaced in the radial direction with respect to the rotor. Therefore, since the gap between the core ring and the rotor can be reduced, the permeability between the core ring and the rotor can be improved, and power consumption of the electromagnetic coil can be drastically reduced. Also, since the fixed portion is integrally provided on the core ring, the number of parts can be decreased as compared with the case where a fixed ring made of a separate part is used.

Also, in order to achieve the above object, the present invention is, in an electromagnetic clutch for compressor provided with a core ring arranged coaxially with a rotational axis of a compressor, an electromagnetic coil provided on the core ring, a fixing member for fixing the core ring to the compressor body and an annular rotor formed surrounding an outer circumferential face and an inner circumferential face of the core ring, in which the rotor is rotatably supported on an outer circumferential face of a support portion extending in the axial direction from the compressor body, the core ring is bonded on one end face in the axial direction of the fixing member and the fixing member is engaged with the compressor body so that movement in the radial direction is regulated, engagement portions are provided for engaging the core ring and the fixing member with each other so that respective movement in the radial direction is regulated.

By this, since the core ring and the fixed member are engaged with each other so that movement in the radial direction is regulated, the fixed member is not displaced in the radial direction with respect to the core ring when the fixed member is bonded, and the axial centers of the core ring and the rotor can be aligned with high accuracy. Therefore, since the gap between the core ring and the rotor can be reduced, the permeability between the core ring and the rotor can be improved, and power consumption of the electromagnetic coil can be drastically reduced.

### BRIEF DESCRIPTION OF THE DRAWINGS

FIG. 1 is a sectional side view of an electromagnetic clutch showing a first embodiment of the present invention;

FIG. 2 is a front view of the electromagnetic clutch;

FIG. 3 is an exploded sectional side view of an essential part of an electromagnetic clutch;

FIG. 4 is a sectional side view of an electromagnetic clutch showing a second embodiment of the present invention;

FIG. 5 is an exploded sectional side view of an essential part of an electromagnetic clutch;

FIG. 6 is an exploded sectional side view of an essential part of the electromagnetic clutch showing a variation of the second embodiment;

FIG. 7 is an enlarged sectional side view of an essential part of the electromagnetic clutch showing a variation;

FIG. 8 is an enlarged sectional side view of an essential part of the electromagnetic clutch showing another variation;

FIG. 9 is a sectional side view of an electromagnetic clutch showing an embodiment of the present invention;

FIG. 10 is a front view of the electromagnetic clutch;

FIG. 11 is an exploded sectional side view of an essential part of an electromagnetic clutch;

FIGS. 12A and 12B are enlarged sectional side views of an essential part of the electromagnetic clutch;

FIGS. 13A and 13B are enlarged sectional side views of an essential part of the electromagnetic clutch showing a variation of an embodiment; and

FIG. 14 is a sectional side view of the electromagnetic clutch of a conventional example.

### DESCRIPTION OF THE PREFERRED EMBODIMENTS

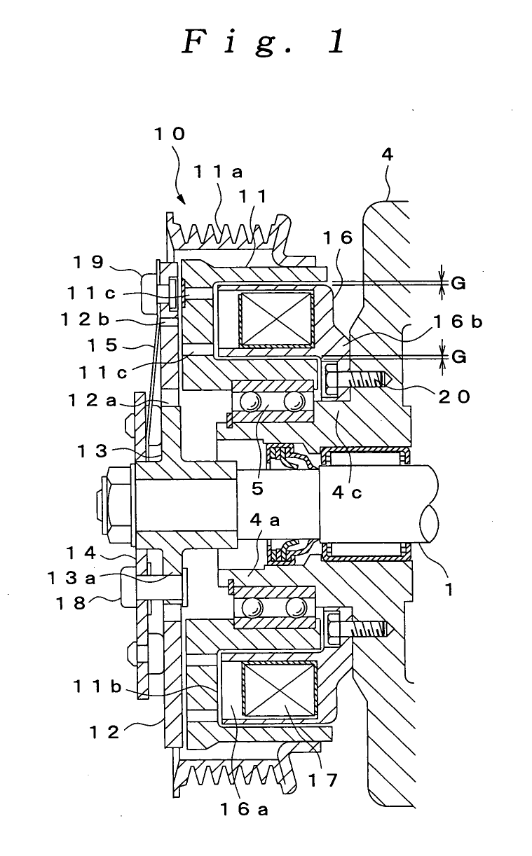

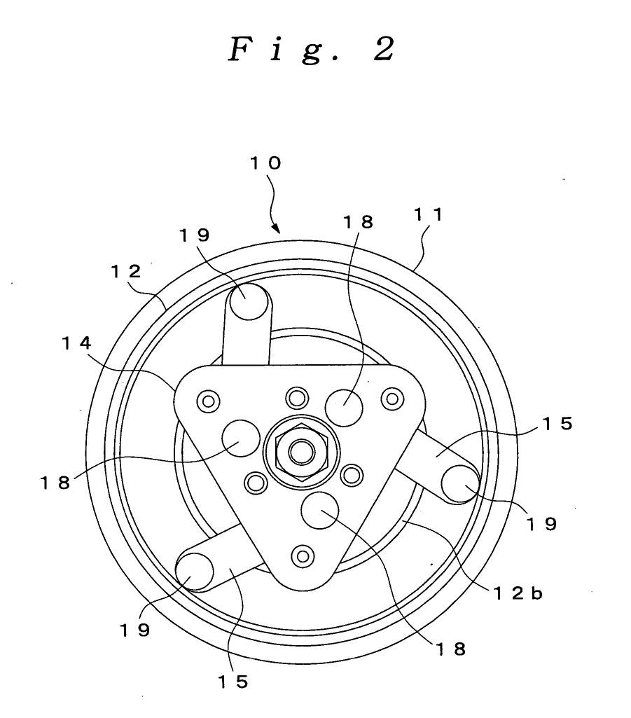

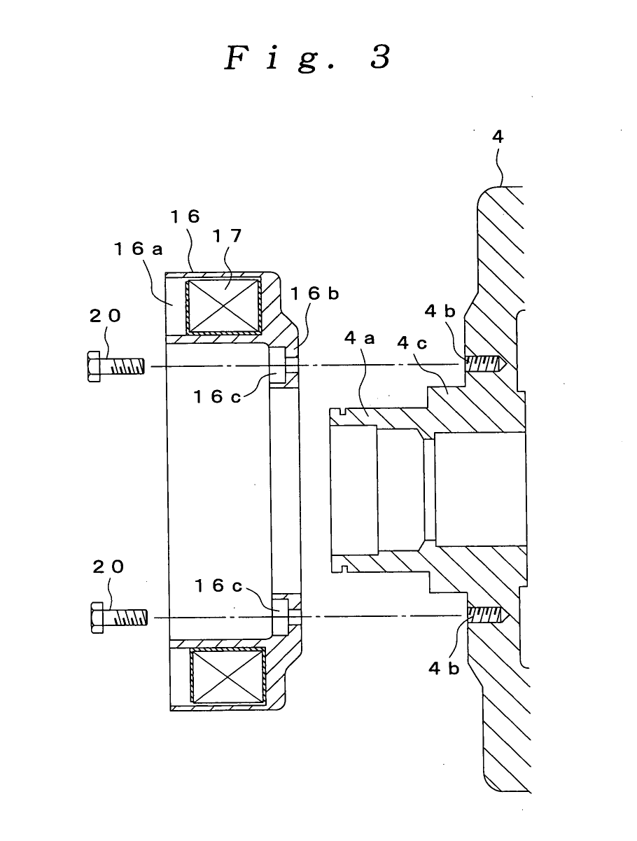

FIGS. 1 to 3 show a first embodiment of the present invention. The components equivalent to those in the conventional example are shown with the same reference numerals.

An electromagnetic clutch 10 shown in these FIGS. is provided with a rotor 11 arranged coaxially with a rotational axis 1 of a compressor, an armature 12 arranged opposite to one end face in the axial direction of the rotor 11, a hub 13 connected to the rotational axis 1 of the compressor, a plate 14 in the approximately triangular shape mounted on the hub 13, a plurality of plate springs 15 for connecting the hub 13 and the armature 12 to each other, a core ring 16 arranged coaxially with the rotor 11 and an electromagnetic coil 17 provided on the core ring 16.

The rotor 11 is made of a metal magnetic material such as iron formed in the annular state, and a belt winding portion 11a around which a multistage belt, not shown, is wound is provided on its outer circumferential face. The rotor 11 is rotatably supported by a support portion 4a of a compressor body 4 via a bearing 5 and its inner circumferential face is fixed onto the outer ring side of the bearing 5. One end face of the rotor 11 is opposed to the armature 12, and an annular recess portion 11b is provided on the other end face side surrounding an outer circumferential face and an inner circumferential face of the core ring 16. On one end face in the axial direction of the rotor 11 is provided an elongated hole 11c extending in the circumferential direction with an interval in the radial direction of the rotor 11, and each of the elongated holes 11c is made to communicate to the respective recess portions 11b.

The armature 12 is made of a metal magnetic material such as iron formed in a disk state, and its one end face in the axial direction is opposed to the one end face of the rotor 11 with a slight gap. At the center of the armature 12, a circular opening 12a through which the hub 13 is inserted is provided, and the inner diameter of the opening 12a is formed larger than the outer diameter of the hub 13. Also, in the armature 12, an elongated hole 12b extending in the circumferential direction is provided, and the elongated hole 12b is located between each of the elongated holes 11c of the rotor 11.

The hub 13 has its one end side in the axial direction coupled to the rotational axis 1 of the compressor, and on the other end side is provided a flange 13a located within the opening 12a of the armature 12.

The plate 14 is arranged on the other end face side of the armature 12 and has its plural points in the circumferential direction coupled to the flange 13a of the hub 13 with a rivet 18.

Each of the plate springs 15 is formed in the straight state, and its one end side is coupled to the flange 13a of the hub 13 together with the plate 14 by the rivet 18. Also, the other end side of each of the plate springs 15 is coupled to the armature 12 with a rivet 19.

The core ring 16 is made of an annularly formed metal magnetic material with the approximately U-shaped section and its one end side in the axial direction is provided with a containing portion 16a for containing the electromagnetic coil 17 in the annular state. The core ring 16 is arranged within the recess portion 11b of the rotor 11, and a gap G is formed in the radial direction between its outer circumferential face as well as the inner circumferential face and the recess portion 11b of the rotor 11, respectively. Also, a fixed portion 16b to be fixed onto the compressor body 4 side is provided integrally on the other end side in the axial direction of the core ring 16, and the fixed portion 16b is formed in the flange state extending inward in the radial direction. Stepped holes 16c penetrating in the axial direction are provided at a plurality of points in the circumferential direction of the fixed portion 16b, and by screwing the bolt 20 inserted in each of the holes 16c into a screw hole 4b provided on one end face in the axial direction of the compressor body 4, the core ring 16 is fixed to the compressor body 4. In this case, an engagement portion 4c having the outer diameter approximately equal to the inner diameter of the fixed portion 16b is provided on the compressor body 4, and by engaging the inner circumferential face of the fixed portion 16b with the engagement portion 4c, radial movement of the core ring 16 is regulated.

The electromagnetic coil 17 is made of a wire-wound conductor applied with insulation coating and fixed within the containing portion 16a of the core ring 16.

In the above constituted electromagnetic clutch 10, when a power of an engine, not shown, is inputted into the belt winding portion 11a of the rotor 11 through the belt, the rotor 11 is rotated coaxially with the rotational axis 1 of the compressor. At that time, when the electromagnetic coil 17 is not electrically connected, the rotor 11 and the armature 12 are held with an interval between them by each of the plate springs 15, and the rotor 11 idles with respect to the armature 12, and the torque of the rotor 11 is not transmitted to the armature 12. When the electromagnetic coil 17 is electrically connected, the electromagnetic coil 17 generates a magnetic force, and the armature 12 is attracted to the rotor 11 side by the magnetic force of the electromagnetic coil 17. By this, the armature 12 is adsorbed to one end face in the axial direction of the rotor 11, the torque of the rotor 11 is transmitted to the armature 12, and the torque of the armature 12 is transmitted to the rotational axis 1 of the compressor through the hub 13.

According to this embodiment, since the fixed portion 16b to be fixed to the compressor body 4 is integrally provided on the core ring 16, the core ring 16 can be formed coaxially with the fixed portion 16b, and the core ring 16 and the fixed portion 16b can be arranged on the same axial center without separate alignment. In this case, since the fixed portion 16b is engaged with the engagement portion 4c of the compressor body 4 so that radial movement is regulated, the fixed portion 16b is not displaced in the radial direction with respect to the rotor 11 and the axial centers of the core ring 16 and the rotor 11 can be aligned with high accuracy. By this, the gap G between the core ring 16 and the rotor 11 can be made smaller, and therefore the permeability between the core ring 16 and the rotor 11 can be improved and the power consumption of the electromagnetic coil 17 can be drastically reduced. Conventionally, a magnetomotive force of 1200 GT has been required, for example, but the magnetomotive force can be lowered to about 800 GT in this embodiment. Moreover, since the fixed portion 16b is integrally provided on the core ring 16, the number of parts can be reduced as compared with the case where a fixed ring made of a separate part is used.

Also, since the fixed portion 16b of the core ring 16 is fixed to the compressor body 4 with a plurality of bolts 20, the conventional welding work is not required but assembling work can be performed extremely easily.

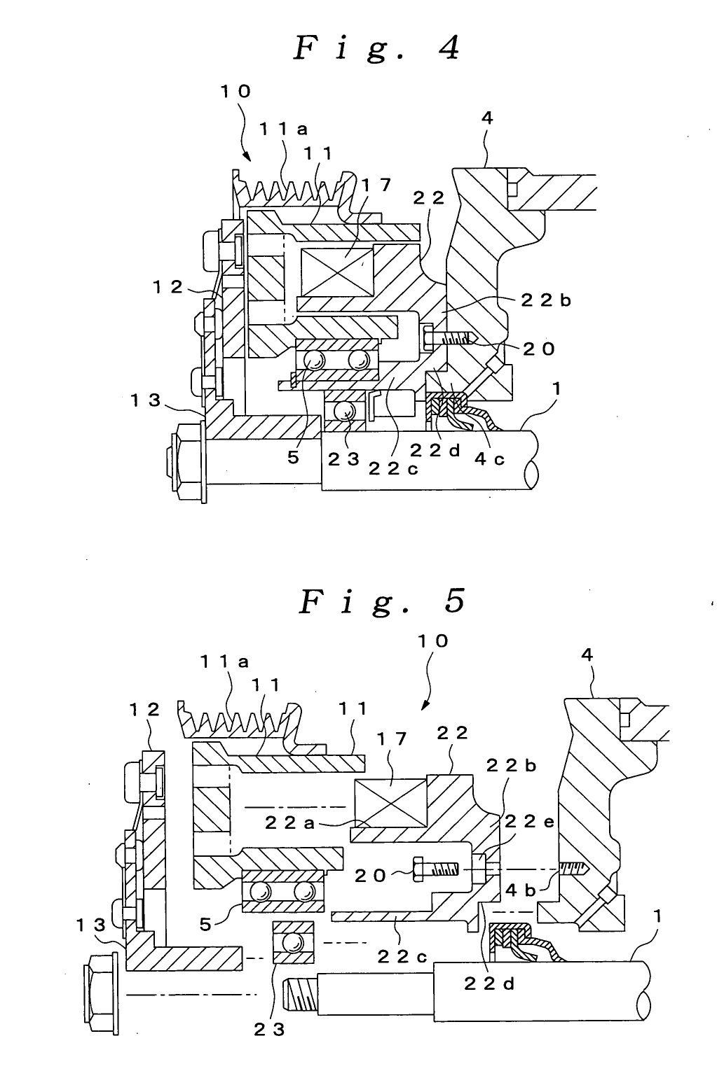

FIGS. 4 and 5 show a second embodiment of the present invention, and FIG. 4 is a sectional side view of the electromagnetic clutch and FIG. 5 is an exploded sectional side view of its essential part. The components equivalent to those in the above embodiment are shown with the same reference numerals.

A core ring 22 shown in the FIGS. integrally has, as in the first embodiment, a containing portion 22a for containing the electromagnetic coil 17 and a fixed portion 22b to be fixed to the compressor body 4 side and is integrally provided with a support portion 22c for supporting the rotor 11. The support portion 22c is formed in the cylindrical state extending from inside in the radial direction of the fixed portion 22b toward one end side in the axial direction,. and the rotor 11 is rotatably supported on its outer circumferential face via the bearing 5. Also, the inner circumferential face of the support portion 22c is rotatably supported by the rotational axis 1 of the compressor via a bearing 23. Between the support portion 22c and the fixed portion 22b is provided a stepped portion 22d having an inner diameter approximately equal to an outer diameter of the engagement portion 4c of the compressor body 4, and by engaging the stepped portion 22d with the engagement portion 4c, radial movement of the core ring 22 is regulated as in the first embodiment. Also, stepped holes 22e penetrating in the axial direction are provided at a plurality of points in the circumferential direction of the fixed portion 22b, and by screwing the bolt 20 inserted into each of the holes 22e into the screw hole 4b of the compressor body 4, the core ring 22 is fixed to the compressor body 4.

According to this embodiment, since the support portion 22c for supporting the rotor 11 is integrally provided on the core ring 22, the core ring 22 can be formed coaxially with the support portion 22c, and the rotor 11 supported by the support portion 22c and the core ring 22 can be arranged on the same axial center without separate alignment. In this case, since the fixed portion 22b is engaged with the engagement portion 4c of the compressor body 4 so that radial movement is regulated, the core ring 22 is not displaced in the radial direction with respect to the compressor body 4 and the axial centers of the core ring 22 and the rotational axis 1 can be aligned with high accuracy. By this, the gap G between the core ring 22 and the rotor 11 can be made smaller, and the permeability between the core ring 22 and the rotor 11 can be improved.

Also, with the constitution of this embodiment, since the fixed portion 22b and the support portion 22c can be integrally formed on the core ring 22 by cold forging, they can be formed by a material with high strength such as iron, for example, and the thickness of the support portion 22c can be thinned.

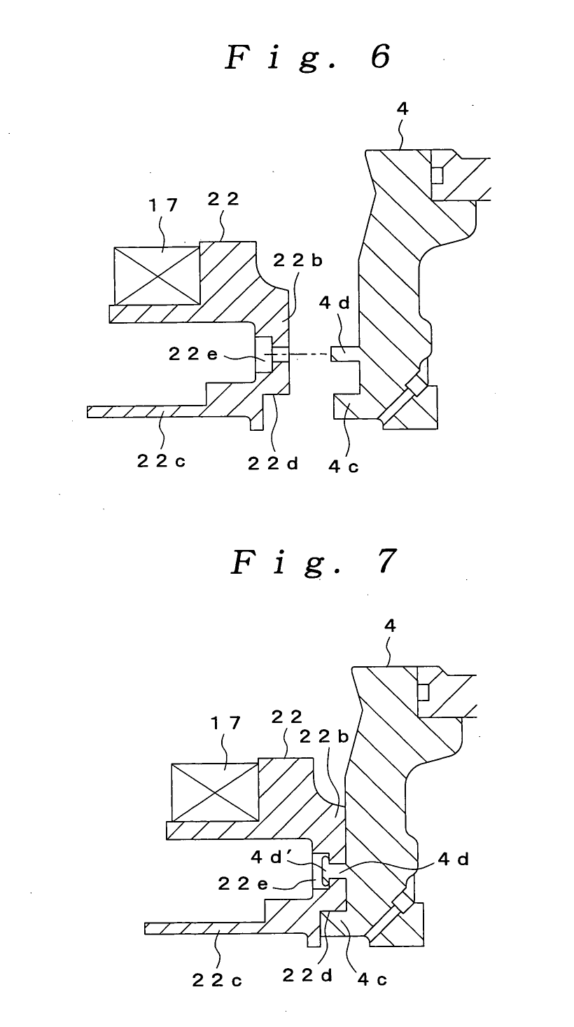

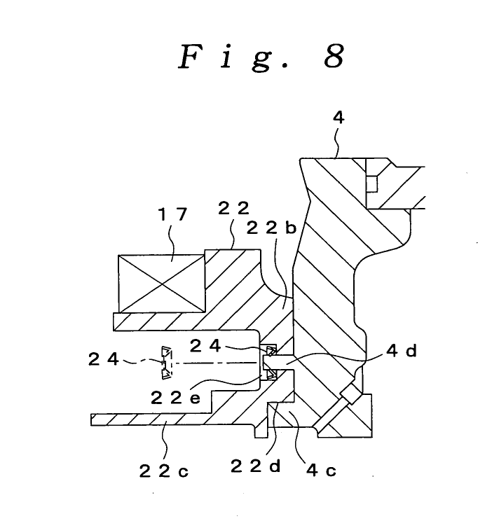

In the above embodiment, the fixed portion 22b of the core ring 22 is fixed to the compressor body 4 with the bolt 20, but the core ring 22 may be fixed to the compressor body 4 by inserting a projection 4d provided on the compressor body 4 as shown in FIG. 6 into the hole 22e of the fixed portion 22b, by deforming the tip end side of the projection 4d so as to be enlarged in the radial direction by caulking as shown in FIG. 7 and by locking this deformed portion 4d′ to the fixed portion 22b. Also, the core ring 22 may be fixed to the compressor body 4 by attaching a locking member 24 locked by the fixed portion 22b on the tip end side of the projection 4d inserted in the hole 22e as shown in FIG. 8. In this case, a known stop ring may be used for the locking member 24. The above fixing structure by caulking and the fixing structure by the locking member 24 may be also used for fixing of the core ring 16 in the first embodiment, respectively.

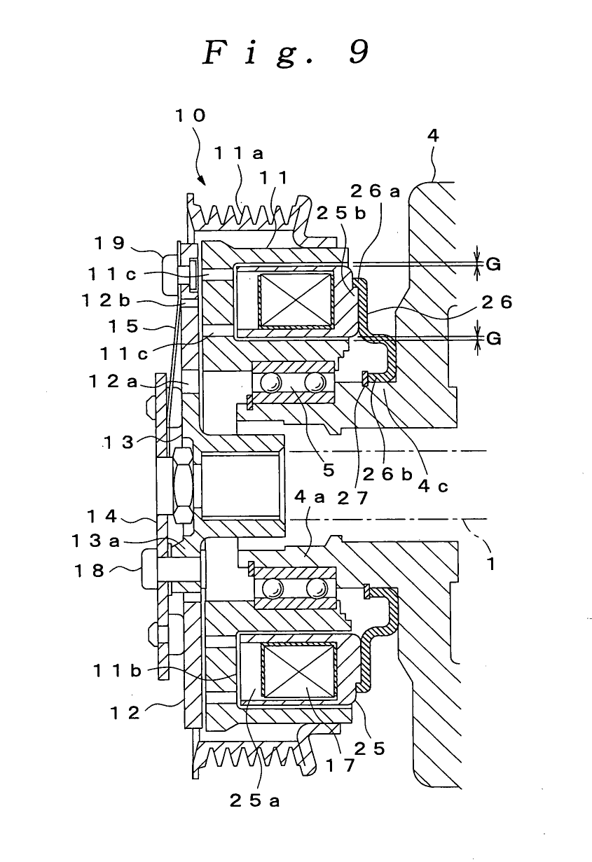

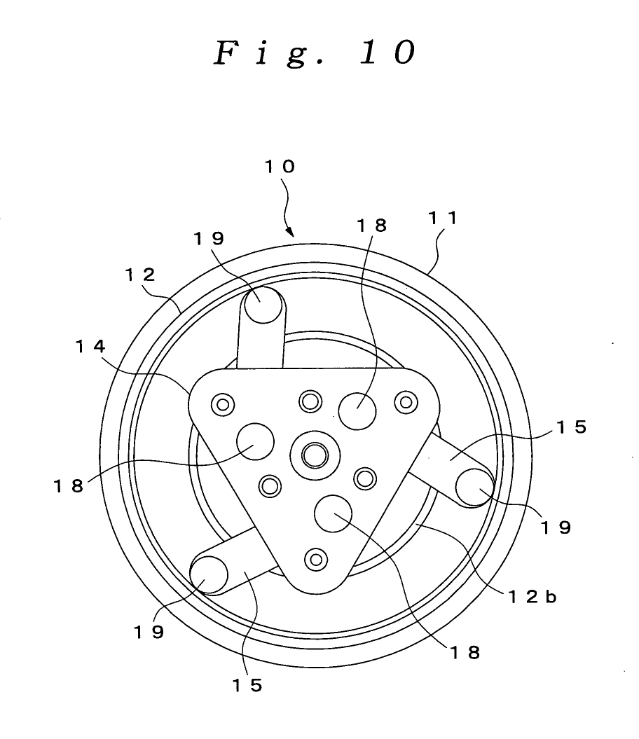

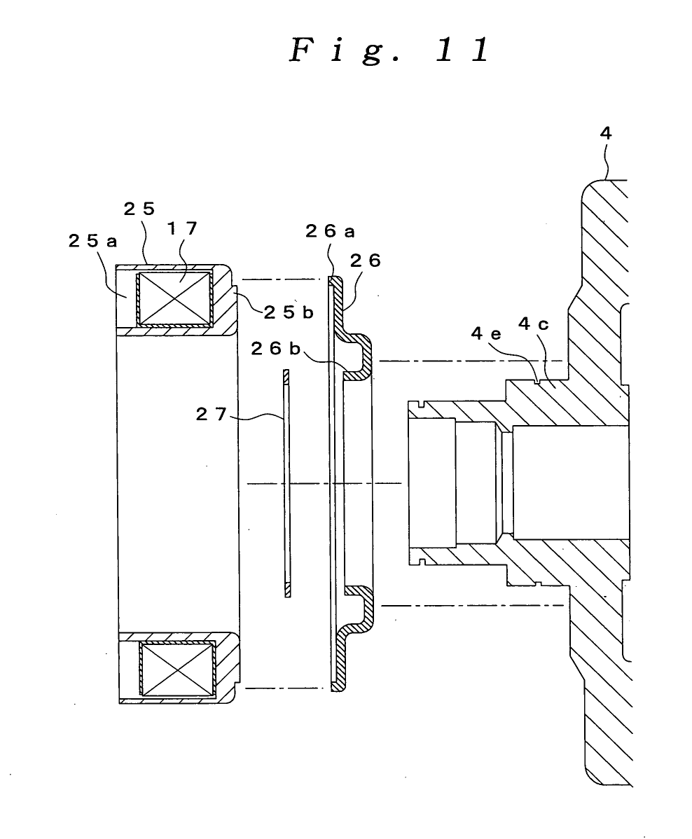

FIGS. 9 to 12 show a third embodiment of the present invention. The components equivalent to those in the above embodiment are shown with the same reference numerals.

An electromagnetic clutch 10 of this embodiment is provided with a fixed ring 26 as a fixed member to be fixed to a core ring 25.

The core ring 25 is made of an annularly formed metal magnetic material with the approximately U-shaped section and is provided with an annular recess portion 25a on its one end side in the axial direction. The core ring 25 is arranged within the recess portion 11b of the rotor 11, and the gap G is formed in the radial direction between its outer circumferential face as well as the inner circumferential face and the recess portion 11b of the rotor 11, respectively. Also, an engagement portion 25b to be engaged with the fixed ring 26 is provided on the other end face in the axial direction of the core ring 25, and the engagement portion 25b is formed annularly so as to form a step in the axial direction.

The fixed ring 26 is made of a disk-state member with its center opened and is arranged between the other end face in the axial direction of the core ring 25 and the one end face in the axial direction of the compressor body 4. A first engagement portion 26a to be engaged with the engagement portion 25b of the core ring 25 is provided outside in the radial direction of the fixed ring 26, and the first engagement portion 26a is formed annularly so as to project in the axial direction. In this case, by engaging the first engagement portion 26a with the engagement portion 25b of the core ring 25, radial movement of the fixed ring 26 with respect to the core ring 25 is regulated. A second engagement portion 26b to be engaged with the compressor body 4 is provided inside in the radial direction of the fixed ring 26, and the second engagement portion 26b is formed extending in the axial direction in the cylindrical state. In this case, an engagement portion 2b having an outer diameter capable of press fitting into the inner circumferential face side of the second engagement portion 26b is provided on the compressor body 4, and by engaging the inner circumferential face of the second engagement portion 26b with the engagement portion 2b, radial movement of the core ring 25 with respect to the compressor body 4 is regulated.

In the above electromagnetic clutch 10, when the core ring 25 is to be fixed to the compressor body 4, first, the fixed ring 26 is bonded to the core ring 25 by projection welding or the like. At that time, by engaging the first engagement portion 26a of the fixed ring 26 with the engagement portion 25b of the core ring 25, radial movement of the fixed ring 26 with respect to the core ring 25 is regulated, and the fixed ring 26 is not displaced in the radial direction with respect to the core ring 25 at bonding.

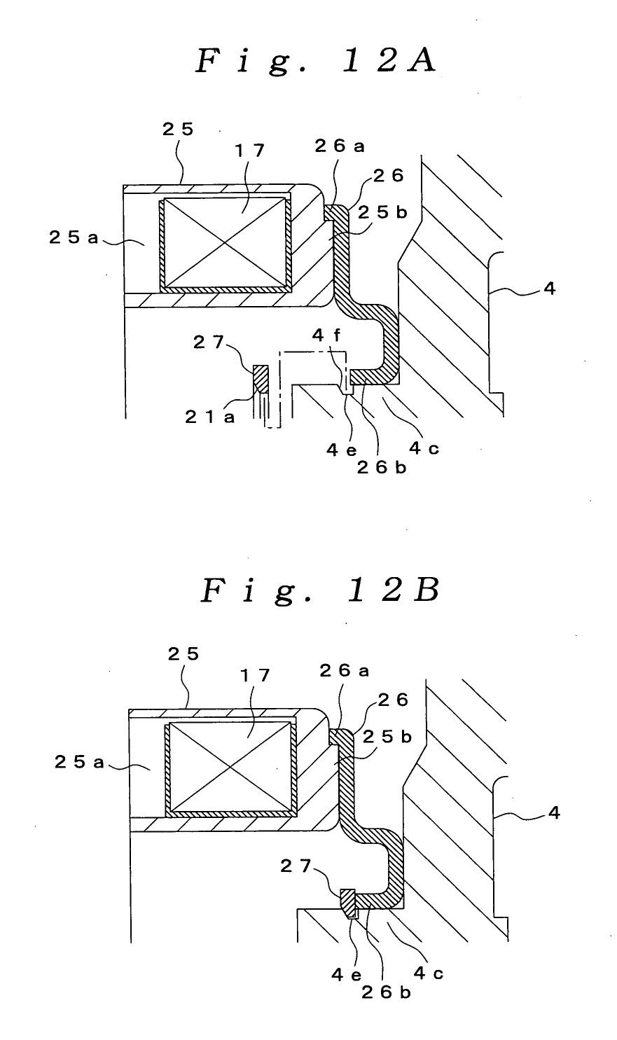

Next, as shown in FIG. 12A, the fixed ring 26 to which the core ring 25 is bonded is fixed to the compressor body 4 with a snap ring 27 as a locking member. At that time, by engaging the second engagement portion 26b of the fixed ring 26 with the engagement portion 4c of the compressor body 4, radial movement of the fixed ring 26 with respect to the compressor body 4 is regulated, and the fixed ring 26 is not displaced in the radial direction with respect to the compressor body 4. Also, since the engagement portion 4c of the compressor body 4 is press-fitted in the second engagement portion 26b of the fixed ring 26, each of the engagement portions 4c and 26b is engaged with each other without a gap. In this case, since the second engagement portion 26b of the fixed ring 26 is formed extending in the axial direction of the compressor body 4, contact area of the compressor body 4 with the engagement portion 4c is made larger.

Also, as shown in FIG. 12B, by fitting the snap ring 27 in an annular groove 4e provided on the compressor body 4, the fixed ring 26 is fixed to the compressor body 4. At that time, the snap ring 27 is locked by the second engagement portion 26b of the fixed ring 26 in the axial direction, and axial movement of the fixed ring 26 is regulated. Also, a tapered surface 27a to be abutted to a tapered surface 4f within the groove 4e is provided inside in the radial direction of the snap ring 27, and by pressing the snap ring 27 inward in the radial direction, the snap ring 27 is slightly moved in the axial direction (on the fixed ring 26 side) with guidance of each of the tapered surfaces 4f and 27a and crimped onto the fixed ring 26 in the axial direction.

In this way, according to this embodiment, since the first engagement portion 26a to be engaged with the engagement portion 25b of the core ring 25 is provided on the fixed ring 26 and each of the engagement portions 25b and 26a is engaged with each other so that radial movement is regulated, the fixed ring 26 is not displaced in the radial direction with respect to the core ring 25 at bonding, and the axial centers of the core ring 25 and the rotor 11 can be aligned with high accuracy. By this, since the gap G between the core ring 25 and the rotor 11 can be made smaller, and the permeability between the core ring 25 and the rotor 11 can be improved and power consumption of the electromagnetic coil 17 can be drastically reduced.

Also, since the second engagement portion 26b to be engaged with the engagement portion 4c of the compressor body 4 is provided on the fixed ring 26 and the second engagement portion 26b is press fitted in the engagement portion 4c of the compressor body 4 in the axial direction, each of the engagement portions 4c and 26b can be engaged with each other without a gap and axial centers can be aligned with higher accuracy.

Moreover, since the second engagement portion 26b of the fixed ring 26 is formed extending in the axial direction of the compressor body 4, the contact area of the compressor body 4 with the engagement portion 4c can be made larger and each of the engagement portions 4c and 26b can be engaged with each other firmly.

Also, since the axial movement of the fixed ring 26 is regulated by attaching the snap ring 27 to be locked by the fixed ring 26 on the compressor body 4 side, the fixed ring 26 can be fixed to the compressor body 4 easily and workability at assembling can be improved.

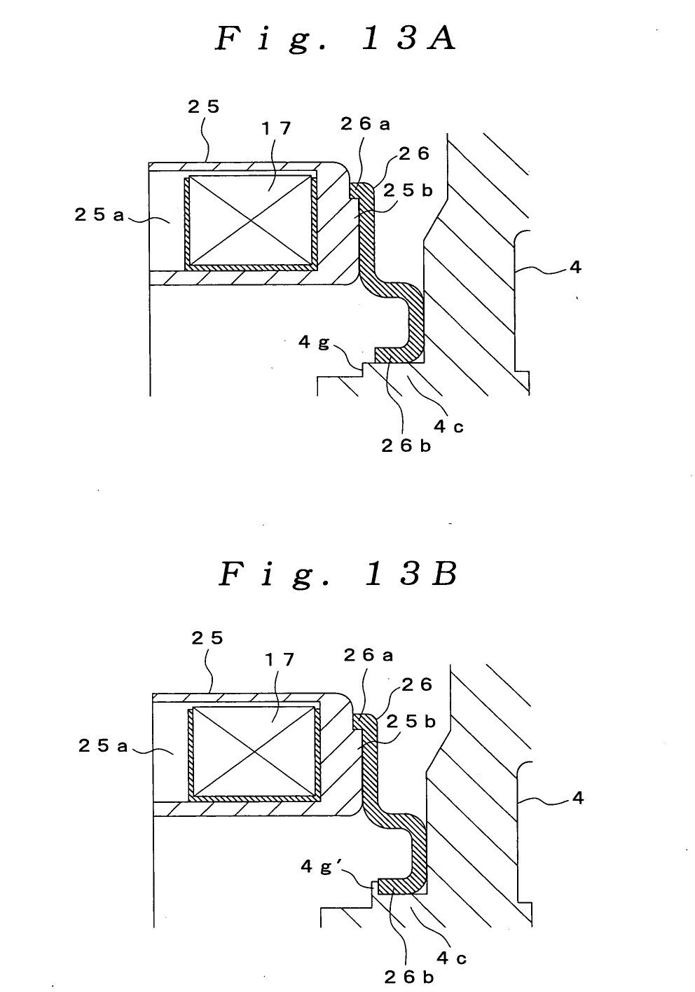

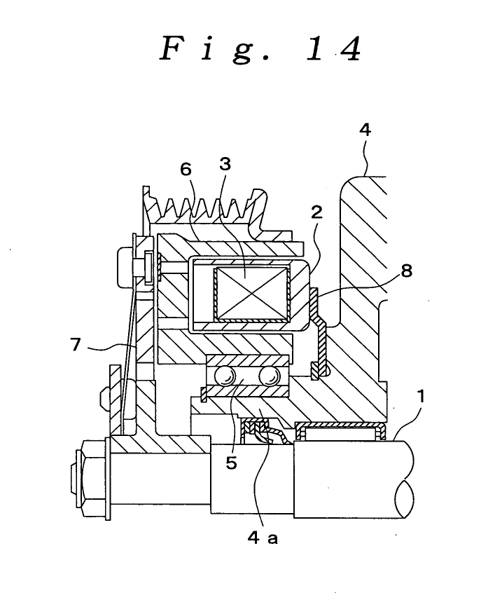

In the above embodiment, an example is shown that the fixed ring 26 is fixed onto the compressor body 4 with the snap ring 27, but the fixed ring 26 may be fixed to the compressor body 4 by providing a stepped portion 4g on one end side of the engagement portion 4c of the compressor body 4 as shown in FIG. 13A, by deforming the stepped portion 4g to be enlarged in the radial direction by caulking as shown in FIG. 13B and by locking this deformed portion 4g′ by the fixed ring 26.

What is claimed is:

1. An electromagnetic clutch for compressor provided with a core ring arranged coaxially with a rotational axis of a compressor, an electromagnetic coil provided on the core ring, and an annular rotor formed surrounding an outer circumferential face and an inner circumferential face of the core ring, in which the rotor is rotatably supported on an outer circumferential face of a support portion extending in the axial direction from a compressor body, wherein:
a fixed portion to be fixed to the compressor body is provided integrally with said core ring, and the fixed portion is engaged with the compressor body so that movement in the radial direction is regulated.

2. The electromagnetic clutch for compressor according to claim 1, wherein
said support portion is integrally provided on said core ring.

3. The electromagnetic clutch for compressor according to claim 1, wherein
the fixed portion of said core ring and the compressor body are fixed to each other with at least one bolt.

4. The electromagnetic clutch for compressor according to claim 1, wherein
the fixed portion of said core ring and the compressor body are fixed to each other by deforming a part of the compressor body and locking it on the fixed portion side.

5. The electromagnetic clutch for compressor according to claim 1, wherein
the fixed portion of said core ring and the compressor body are fixed to each other by attaching on the compressor body side a locking member for locking on the fixed portion side.

6. An electromagnetic clutch for compressor provided with a core ring arranged coaxially with a rotational axis of a compressor, an electromagnetic coil provided on the core ring, a fixing member for fixing the core ring to a compressor body and an annular rotor formed surrounding an outer circumferential face and an inner circumferential face of the core ring, in which the rotor is rotatably supported on an outer circumferential face of a support portion extending in the axial direction from the compressor body, the core ring is bonded on one end face in the axial direction of the fixing member and the fixing member is engaged with the compressor body so that movement in the radial direction is regulated, comprising:
engagement portions provided on said core ring and the fixing member so that the respective movement in the radial direction is regulated.

7. The electromagnetic clutch for compressor according to claim 6, wherein
the engagement portion to be engaged with the compressor body in said fixing member is formed capable of press-fitting in the axial direction on the compressor body side.

8. The electromagnetic clutch for compressor according to claim 7, wherein
the engagement portion to be engaged with the compressor body in said fixing member is formed extending in the axial direction of the compressor body.

9. The electromagnetic clutch for compressor according to claim 6, wherein
the fixing member is fixed to the compressor body so that movement in the axial direction is regulated by attaching on the compressor body side a locking member for locking on said fixing member.

10. The electromagnetic clutch for compressor according to claim 6, wherein
the fixing member is fixed to the compressor body so that movement in the axial direction is regulated by deforming a part of said compressor body and locking it on the fixing member side.
